(19) United States
(12) Patent Application Publication
(10) Pub. No.: US 2021/0114636 A1
(43) Pub. Date: Apr. 22, 2021

(54) CONVEYOR SYSTEM AND METHOD FOR CONTROLLING SUCH A CONVEYOR SYSTEM

(71) Applicant: EISENMANN SE, Böblingen (DE)

(72) Inventor: Herbert Schulze, Aidlingen (DE)

(21) Appl. No.: 17/048,860

(22) PCT Filed: Apr. 12, 2019
(86) PCT No.: PCT/EP2019/059525

§ 371 Date: Oct. 19, 2020

(30) Foreign Application Priority Data
Apr. 20, 2018 (DE) 10 2018 109 584.8
Jul. 10, 2018 (DE) 10 2018 116 624.9

(51) Int. Cl. B61L 23/00; B62D 53/00; B61L 25/02

(52) U.S. Cl. CPC B61L 23/005; B61L 25/02; B62D 53/005

(57) ABSTRACT

A conveyor system has a conveyor section, at least one first moving trolley which carries along a dedicated drive and is movable with the latter along the conveyor section and which has a first trolley parameter, and a controller which, taking into consideration the first trolley parameter triggers various actions with the aid of waypoints along the conveyor section. For more flexible use of the conveyor system, at least one second moving trolley having a second trolley parameter differing from the first trolley parameter is provided, and the controller is designed to place at least one waypoint along the conveyor section, at which waypoint a certain action is triggered, for the second moving trolley at a different position along the conveyor section than for the first moving trolley.

### CROSS-REFERENCES

The following application is closely linked to the application DE 10 2018 109 584 of 20 Apr. 2018, the contents thereof being hereby incorporated by way of reference in the contents of the present application.

### BACKGROUND TO THE INVENTION

### 1. Field of the Invention

The invention relates to a conveyor system having

a) a conveyor section,

b) at least one first moving trolley which carries along a dedicated drive and is movable with the latter along the conveyor section and which has a first trolley parameter, and

c) a controller which, taking into consideration the first trolley parameter, triggers various actions with the aid of waypoints along the conveyor section.

The invention further relates to a method for controlling such a conveyor system.

### 2. Description of the Prior Art

Conveyor systems are known from the prior art, in which the conveyor section is composed of various section portions. Thus rail systems, such as for example a single-rail floor track, is known in which various linear rail pieces, curved rail pieces and track branchings and track combinations and movable rails are used.

Curved section portions may be provided for changing the direction of movement of the moving trolley in the vertical and/or horizontal direction.

Moreover, after the moving trolley leaves the branching, the track branchings provide the moving trolley with section portions which are different from one another. Track combinations, however, provide the possibility of moving from different section portions to a common section portion of the conveyor section.

Such conveyor systems serve, for example, for transporting workpieces in at least one part of a larger production plant. Such a part of a production plant for workpieces, for example, may be a manufacturing area, a surface treatment area, a storage area, an assembly area, a control area and/or a connecting area between other parts of the production plant.

In this case, the conveyor system may simply have the function of transporting the workpieces between two areas. However, it is also possible that the conveyor system moves the workpieces through a process step within the areas. The moving trolleys, therefore, are in some cases stopped at specific stations so that a corresponding process step may be carried out on the workpiece.

In order to follow the path of the traveled section and, in particular, of a rail, the moving trolleys have a chassis with a drive which is carried along, for example in the form a friction wheel. Moreover, such a chassis may have further guide elements, such as for example guide rollers.

In this case the drive generally comprises an electrical geared motor, the power supply thereof being provided by sliding conductor lines along the conveyor section or energy storage devices which are carried along, such as rechargeable batteries, compressed gas containers and/or capacitors. Inductive energy concepts are also known.

The control of such a conveyor system is carried out via a so-called system controller. In this case according to the “divide and conquer” principle the complex sequences of the entire production plant are broken down into smaller logical units. Thus also when designing the conveyor system. Thus concepts are known in which the system controller provides the moving trolley only with targets to which it is designed to move and the moving trolleys in turn carry dedicated moving trolley controllers which control the movement of the moving trolleys, in particular the travel speeds thereof.

Thus, for example, changes to the travel speed of the moving trolleys are necessary when these moving trolleys move through a curved region of the conveyor section. Thus in some cases higher mechanical loads may act on the chassis of the moving trolleys in a curved region, relative to a linear conveyor section.

It may also be necessary that from time to time the moving trolleys come to a halt at specific points of the conveyor system. This may be required, for example, at the corresponding treatment and/or handling areas. When the track alteration devices switch over, this may also require a brief stoppage of the moving trolleys.

An action such as changing the travel speed or stopping the moving trolley is carried out, therefore, as a function of the position of the moving trolley along the conveyor section.

Generally, therefore, on such conveyor systems waypoints at which specific actions are triggered are predetermined along the route. In this case the waypoints may be provided as physical switches, which for example switch a moving trolley upstream of a curved section to a slower travel speed. Typically, however, the waypoints are provided virtually by the system controller. To this end, for example, the moving trolleys may carry a reader device by which position codings may be read along the conveyor section. The system controller then predetermines a specific position along the conveyor section as a waypoint.

The position of the waypoints along the conveyor section is fixed when the conveyor system is designed. In this case the position of the waypoints essentially depends on the action to be triggered, the envisaged travel speeds at the waypoint and/or the other structural specifications.

Primarily, however, the position of the waypoints depends on the trolley parameters of the moving trolleys used in the conveyor system. Thus moving trolleys of equal length are always used in a conveyor system. When designing the conveyor system and implementing the system controller, therefore, depending on the moving trolleys used, for example, a waypoint is placed upstream of a track switch at a suitable position for the length of the moving trolley.

The arrangement of the waypoints, therefore, is fixed during the design of the conveyor system according to the requirements of the production plant and primarily the technical properties, i.e. the trolley parameters, of the selected moving trolley type which will be used in the system.

This initially planned arrangement is then generally corrected in a pre-operating phase, still within very narrow limits, in order to achieve a maximum system throughput. Thus moving trolleys with differing trolley parameters may not be used in such conveyor systems, or only to a very limited extent.

### SUMMARY OF THE INVENTION

It is, therefore, the object of the invention to provide a conveyor system which is more flexible regarding the use of different moving trolleys.

This is achieved according to the invention by a conveyor system of the type mentioned in the introduction, in which

d) at least one second moving trolley having a second trolley parameter differing from the first trolley parameter is provided, and

e) the controller is designed to place at least one waypoint along the conveyor section, at which waypoint a certain action is triggered, for the second moving trolley at a different position along the conveyor section than for the first moving trolley.

The inventor has recognized that it may be sometimes expedient to use the waypoints which are located along the conveyor section for triggering different actions, depending on the incoming moving trolleys, and namely when moving trolleys having different trolley parameters have to be moved on one and the same conveyor system.

This is particularly the case when a towing method disclosed in the hitherto unpublished DE 10 2018 109 584.8 is used. In this document, broken-down moving trolleys are moved by other moving trolleys out of inaccessible section portions.

By means of the present invention, the resulting moving trolley, which has a trolley parameter which differs from normal operation, may nevertheless be moved reliably through the conveyor section. For the remaining moving trolleys, nothing changes relative to the waypoints.

The position of the waypoint for the second moving trolley in this case may be permanently provided at a different position from the waypoint for the first moving trolley.

Thus, for example, the two waypoints for the first and the second moving trolley may be mounted at different positions along the conveyor section but in each case only act on the first or the second moving trolley and/or the two moving trolleys in each case may react to only one of the two waypoints. For example, in each case two different stop waypoints may be provided for the two moving trolleys upstream of a track alteration device such as a track switch, or the like.

However, the waypoints may only be displaced in the controller, as required. For example, this may only take place in the case of a second moving trolley which is actually present in the conveyor section, so that the waypoints for the corresponding actions are effectively only displaced temporarily for the moving trolley with a differing trolley parameter.

The specific action is an action which is the same both for the first moving trolley and for the second moving trolley. In particular, the specific action is changing a speed, halting at a stop point and/or opening up a section.

Preferably it is provided that the first and second trolley parameter is a trolley length, a mass, a maximum acceleration, a speed and/or a functional length of the moving trolleys.

The trolley parameters in which the first and the second moving trolley differ are initially to be understood primarily as those parameters which influence the travel behavior of the moving trolleys. In particular, however, it is possible that the relevant trolley parameters are the aforementioned parameters. In this case, the maximum acceleration may be understood both as the acceleration and the deceleration.

The functional length is a length virtually predetermined by the controller, which in normal operation predetermines a sufficient minimum distance between two moving trolleys, influences the speed during cornering and/or predetermines a necessary stopping distance from a track alteration device. Typically, conveyor systems are designed using such a functional length of the moving trolleys.

Frequently, the functional length is also provided by the maximum length of the workpieces to be conveyed and/or the maximum trolley length. However, allowances for safety distances may also be incorporated in the functional length.

Preferably, it is provided that the second trolley parameter of the second moving trolley differs from the first trolley parameter of the first moving trolley due to a coupling of two moving trolleys.

By the coupling of two moving trolleys, for example, the functional length is extended, which may be taken into consideration in the controller according to the invention by the waypoints which are displaced for performing actions.

During the coupling of two moving trolleys, preferably a separating device may be used, the power flow between the drive and conveyor section being interrupted thereby on a moving trolley. The drive is then implemented via the other coupled-on moving trolley. As a result, a moving trolley train is produced from two coupled moving trolleys, wherein depending on whether it is pushed or pulled, only the drive of the rear trolley or the front trolley is used.

Preferably, it is provided that one of the two coupled moving trolleys is a moving trolley which has broken down due to a technical fault.

In this manner, a broken-down moving trolley may be towed. Towing in this case may encompass both pushing the broken-down moving trolley and also pulling it from behind.

Frequently, the moving trolley controller which is carried on the moving trolleys malfunctions. Thus it may be advantageous to use the still functional drive of a broken-down moving trolley, when the moving trolleys are coupled together, by a power-transmitting connection being produced on the two vehicles, for example by means of rigid and/or movable electrical contacts. Advantageously, at least one of the electrical contacts is spring-loaded. The electrical contact may take place with or without a mechanical coupling of the vehicles to one another.

Moreover, it is advantageous for the electrical coupling if relative movements of the moving trolleys to one another may be at least partially compensated by the electrical connection, without the connection being disconnected. Provided the electrical connection is made, this is determined by a pilot contact and the designated components for this fault may be used. For example, each moving trolley may be provided with a switching unit which in the case of a fault, electrically isolates the drive motor and the electrical brake of the broken-down moving trolley from the power supply components thereof, via an external signal and/or an external power supply from the towing moving trolley, and instead connects said components to the electrical components of the towing moving trolley.

Preferably, it is provided that one of the two coupled moving trolleys is a towing trolley.

In principle, all of the moving trolleys may be designed as conveyor trolleys, so that a broken-down conveyor trolley may be towed by a different conveyor trolley. A separate towing trolley which in its construction differs from the other conveyor trolleys, however, may be advantageous. Thus the towing trolley may have a shorter trolley length so that the functional length of the two coupled moving trolleys only differs slightly relative to the functional length of a conveyor trolley. This may be relevant, for example, for transfer units or lifting stations. Moreover, the other conveyor trolleys are able to remain with their workpieces in the normal process sequence.

The towing trolley may also be designed as a mobile unit which may be used by operating personnel at any position of the conveyor section which is accessible to operating personnel in order to retrieve a broken-down moving trolley from an inaccessible area. As a result, only a smaller portion of the conveyor section has to be opened up for towing the broken-down moving trolley.

Preferably, it is provided that the controller is designed such that the specific action which is carried out at the waypoint also takes into consideration the difference of the second trolley parameter from the first trolley parameter.

For example, the travel speed in the two coupled moving trolleys may be reduced upstream of a curved portion not only earlier but also to a greater extent. Generally, the action at the displaced waypoint, therefore, may take into consideration in particular the reduced maximum acceleration and deceleration values, the increased functional length, the reduced speed and/or the increased mass. For example, a moving trolley may have a parameter storage device for its own trolley parameters which may be altered in the case of the towing situation.

Preferably, it is provided that the two moving trolleys carry a moving trolley controller with a waypoint storage device and a device for detecting the actual position along the conveyor section and the second moving trolley stores in the waypoint storage device a different waypoint for the specific action.

In this case, the moving trolley controller in each case may obtain individual waypoints from the higher-order controller of the conveyor system to which the moving trolleys then move. In this case, the controller transfers to the second moving trolley a different waypoint for the specific action than to the first moving trolley.

However, different sets of waypoints may also be stored in the waypoint storage device, said waypoints then being used either by the first moving trolley or by the second moving trolley.

Alternatively, the moving trolley controller may contain at least one offset value which generates the waypoints of the second vehicle from the waypoints of the first vehicle. The offset value in turn may take into consideration the differing trolley parameter.

The moving trolley controller may also be designed to be less intelligent, by the data of the reader device continuously being transmitted to the higher-order controller of the conveyor system, so that the specific action is triggered at a waypoint by this higher-order controller. The information about the different waypoints for the first and/or the second moving trolley, therefore, is only stored in the higher-order controller.

Preferably, it is provided that the displaced waypoint results in the application of emergency travel parameters on the second moving trolley.

Preferably, it is provided that a moving trolley with differing trolley parameters communicates this to the controller and/or the other moving trolley.

In this manner the controller, for example due to an increased functional length or insufficient drive force for two moving trolleys, is able to block specific portions of the conveyor section for this moving trolley.

Regarding the method, the object of the invention is achieved by a method for controlling the conveyor system described in the introduction, having the following steps:
providing at least one second moving trolley having a second trolley parameter which differs from the first trolley parameter;
placing at least one waypoint along the conveyor section, at which waypoint a certain action is triggered, for the second moving trolley at a different position along the conveyor section than for the first moving trolley.

Preferably the following steps are also provided:
for towing a moving trolley which has broken down due to a technical fault, in particular in a portion of the conveyor section which is difficult to access for operating personnel, coupling a different moving trolley onto the broken-down moving trolley, whereby the second moving trolley is produced;
moving the second moving trolley by taking into consideration the displaced waypoint.

In this manner, broken-down moving trolleys may be towed.

### BRIEF DESCRIPTION OF THE DRAWINGS

Exemplary embodiments of the invention are described in more detail hereinafter with reference to the drawings. In which:

FIG. 1 shows a schematic view of a conveyor system having a conveyor section which comprises different portions and branches;

FIG. 2 shows a side view of a portion of the conveyor section in which a plurality of conveyor trolleys are shown at their normal operating distance;

FIG. 3 shows a side view according to FIG. 2, wherein two of the conveyor trolleys are shown coupled together, however;

FIG. 4 shows a side view of the conveyor section in the region upstream of a track switch, with a conveyor trolley which moves toward two waypoints for controlling its drive;

FIG. 5 shows a side view according to FIG. 4, wherein the conveyor trolley is located on the first of the two waypoints;

FIG. 6 shows a side view according to FIG. 4, wherein the conveyor trolley is located on the second of the two waypoints;

FIG. 7 shows a side view according to FIG. 4, wherein two coupled conveyor trolleys move toward two waypoints which in comparison with the two waypoints of FIGS. 4 to 6 are positioned further upstream of the track switch;

FIG. 8 shows a side view according to FIG. 7, wherein the coupled conveyor trolleys are located at the first of the two waypoints shifted forward;

FIG. 9 shows a side view according to FIG. 7, wherein the coupled conveyor trolleys are located at the second of the two waypoints shifted forward;

FIG. 10 shows a side view according to FIG. 7, wherein a conveyor trolley is shown to which a towing trolley approaches;

FIG. 11 shows a side view according to FIG. 10, wherein the towing trolley has been coupled onto the conveyor trolley;

FIG. 12 shows a side view according to FIG. 10, wherein the towing trolley is located at the second waypoint which in this case has been shifted downstream.

### DESCRIPTION OF PREFERRED EXEMPLARY EMBODIMENTS

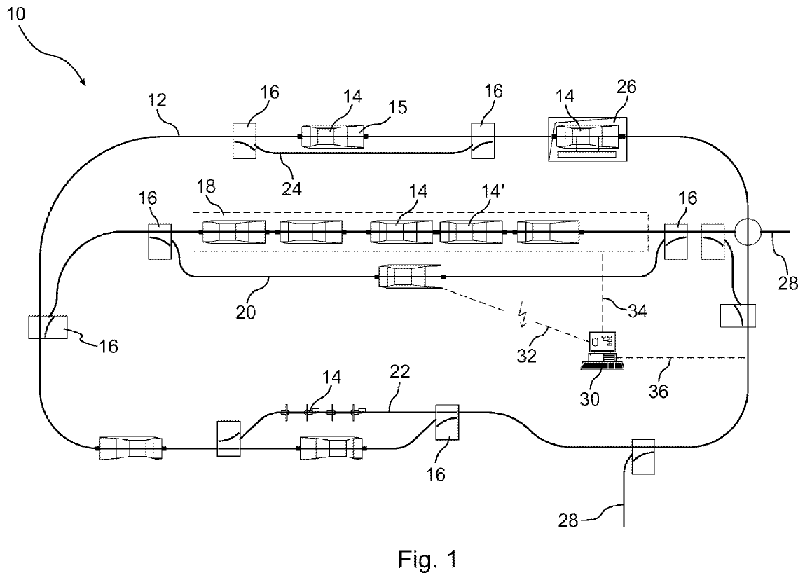

In FIG. 1 a conveyor system, denoted as a whole by the reference numeral 10, is shown with a conveyor section 12 and a plurality of conveyor trolleys 14 at different positions along the conveyor section 12.

The conveyor section 12 comprises different section portions which in the plan view approximately show two circuits nested in one another, between which the conveyor trolleys 14 and the workpieces conveyed thereby, here by way of example vehicle bodies 15, may alternate to and fro by means of a plurality of track switches 16 as track alteration devices.

In order to illustrate where the invention is particularly useful, FIG. 1 shows in the center a section portion of the conveyor section 12 which represents an area which is difficult to access for operating personnel, which here by way of example is intended to be a painting booth 18. Thus as becomes clear below by means of the further figures, inside the painting booth 18 the conveyor trolleys 14 are guided below a partition floor and the vehicle bodies 15 are guided above the partition floor.

Via the two track switches 16 upstream and downstream of the painting booth 18 the conveyor trolleys 14, in which the conveyed vehicle bodies 15 are not intended to be painted, are guided on a bypass section 20 which runs parallel to the painting booth 18.

In the lower region of FIG. 1, a servicing section 22 of the conveyor section branching off from the main section is identifiable, conveyor trolleys 14 generally without a conveyed vehicle body 15 being able to be serviced and/or parked therein.

An idling buffer 24, in which conveyor trolleys 14 including the vehicle bodies 15 may be buffered, is shown by way of example in the upper region of FIG. 1.

Moreover, along the conveyor section 12 (top right in FIG. 1), a transfer unit 26 is also shown, the conveyor trolleys 14 being able to be relocated thereby onto a different transport plane, for example for further assembly of the motor vehicle. The transfer unit 26 is also a section portion of the conveyor section 12 which is difficult to access for operating personnel.

Finally, the conveyor section 12 comprises links 28 to further conveyor systems of an entire higher-order production plant.

A system controller 30, which here by way of example may communicate via a wireless communication link 32 with the conveyor trolleys 14, is provided for controlling the conveyor system 10. Alternatively or additionally, primarily in a rail-guided conveyor system 10 as shown here, communicating sliding conductor lines may be used along the conveyor section 12 for communicating with the conveyor trolleys 14.

Moreover, the system controller 30 is also connected via a communication link 34 to the manufacturing systems, in this case the painting booth 18 and/or the working components thereof such as the painting robots. Typically, the manufacturing systems have individual controllers dedicated thereto which only receive higher-order commands from the system controller 30 and internally control the appropriate movement, for example, of the painting robots.

Finally, the system controller 30 is connected via a communication link 36 to the conveyor section 12, i.e. in particular to the track switches 16 arranged along the conveyor section 12 and/or other actuators and sensors influencing the track.

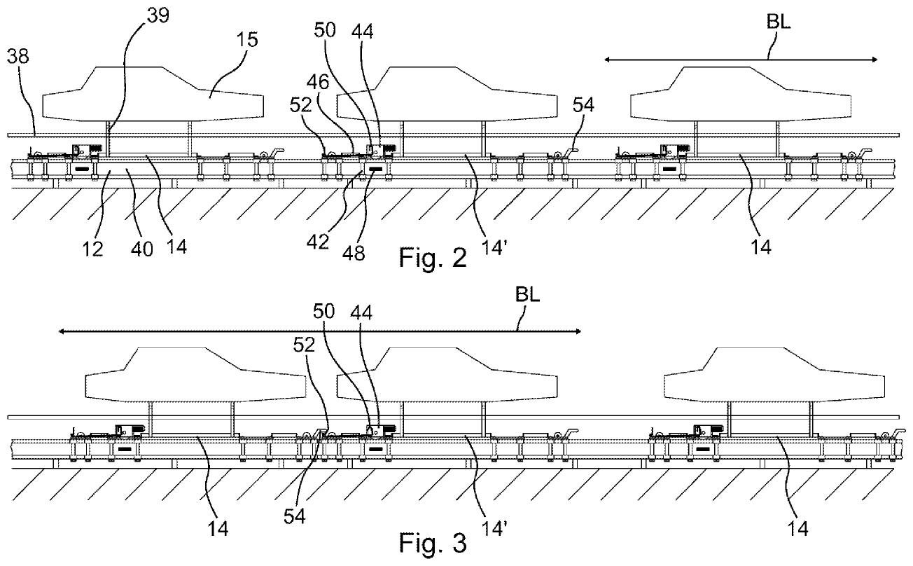

In FIGS. 2 and 3 a section portion of the conveyor section 12 in the painting booth 18 is shown in a sectional view.

In this case only one partition floor 38 of the painting booth is shown, said partition floor dividing a travel space of the booth, in which the conveyor trolleys 14 move and in which the vehicle bodies 15 are guided. To this end the partition floor 38 has a longitudinal gap through which supporting rods 39 of the conveyor trolleys 14 protrude.

Initially it may be identified that the conveyor section 12 is predetermined by a rail 40, along which a conveyor trolley 14 with the conveyed vehicle body 15 is moved. To this end, the conveyor trolley 14 has a chassis 42 which has a dedicated drive 44 by which the conveyor trolley may move by its own power along the rail 42. For controlling the drive 44 the conveyor trolley 14 also carries a moving trolley controller 46 which reads by means of a reader device 48, for example, barcodes or other markings attached to the rail 42, in order to determine the position of the conveyor trolley along the route 12. For details of an exemplary barcode positioning system, reference should be made to DE 10 2012 010 677 A1.

Moreover, the trolley 14 has a separating device 50 by which the non-positive connection between the drive motor 44 and the conveyor section 12 may be disconnected, by actuating elements 52, 54 being actuated on the front and/or rear end of the conveyor trolley. Typically, the power flow is interrupted at a transmission of the drive. For details of the design of the separating device 50, reference should be made to the hitherto still unpublished DE 10 2018 109 584 of the applicant.

As shown in FIG. 3, the separating device 50 may be used to tow a broken-down conveyor trolley 14′ with a further conveyor trolley 14.

To this end, as visible in FIG. 3, the trailing conveyor trolley 14 travels toward the broken-down conveyor trolley 14′, whereby the separating device 50 is actuated. Additionally, a coupling of the two trolleys may be carried out. The drive 44 of the broken-down conveyor trolley 14′ is now virtually idling so that the trailing conveyor trolley 14 forms with the broken-down conveyor trolley 14′ a coupled vehicle combination.

Frequently, a conveyor trolley 14′ remains stationary since an electrical component malfunctions. Thus it may be advantageous if an electrical bypass contact is produced at the same time as the coupling, by which the towing conveyor trolley 14, for example, may perform a diagnosis or may use still functioning sensors, such as for example a front distance sensor of the damaged conveyor trolley 14′.

The controller 30 may identify a broken-down conveyor trolley 14′, for example by a distance sensor system on the trailing conveyor trolley 14 identifying a safety distance being dropped below, and communicating this to the controller 30. Moreover, sensor systems along the conveyor section 12 may report that an anticipated conveyor trolley 14 has not reached a sensor position within a predetermined time. The controller 30 may then issue the command to move toward the broken-down conveyor trolley 14.

After being successfully coupled-on, the controller 30 establishes where the broken-down conveyor trolley 14′ has to be moved to and prepares the corresponding track alteration devices. The controller 30 may also inform the remaining process controller about the loss of the two conveyor trolleys.

By the coupling of the two conveyor trolleys 14 and 14′ the trolley parameter which is relevant for the movement of the still functioning conveyor trolley 14 is changed. For example, a trolley parameter is its functional length in normal operation BL (see FIG. 2) which increases by the coupling to a functional length in emergency operation NL (see FIG. 3).

As described hereinafter the trolley parameters play an important role in the control of the conveyor system 10.

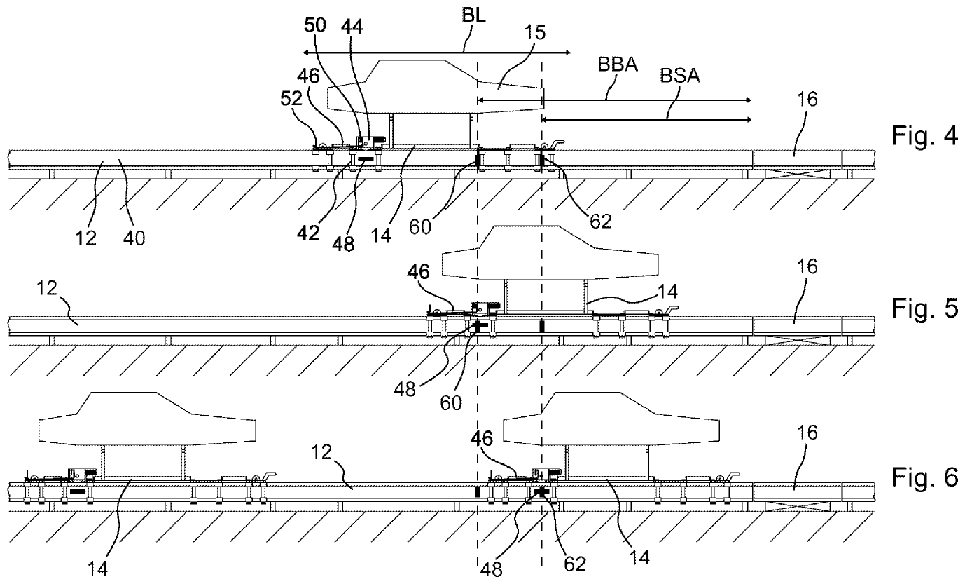

FIGS. 4 and 6 show a portion of the conveyor section 12 upstream of a track switch 16.

For controlling the conveyor system 10 the system controller 30 of the moving trolley controller 46 predetermines waypoints in which specific actions are carried out when reached. These waypoints are virtual waypoints which are defined in the system controller 30 and during the design of the conveyor system 10 are fixed when designing the conveyor section 12.

Thus in FIGS. 4 to 6, a braking waypoint 60 is arranged upstream of the track switch 16 with a predetermined operating braking distance BBA, and slightly downstream along the conveyor section a stop waypoint 62 is arranged at the operating stopping distance BSA. All of the waypoints, i.e. also the braking waypoint and the stop waypoint 62, are adapted in each case to the functional length in normal operation BL of the conveyor trolleys 14.

In FIG. 5 the conveyor trolley 14 has reached the braking waypoint 60 which is identified by the reader device 48 of the moving trolley controller 46. Due to a previous prediction on the part of the system controller 30, the moving trolley controller 46 at this position reduces the travel speed of the conveyor trolley 14.

In FIG. 6 the conveyor trolley 14, traveling more slowly, has reached the stop waypoint 62 which is identified in turn by the reader device 48. In this position the conveyor trolley 14 stops and waits until the track switch 16 provides the correct track.

Since the functional length BL and the placing of the braking waypoint 60 and the stop waypoint 62 are taken into consideration when designing the conveyor system 10, the conveyor trolley 14 comes to a halt such that its front end does not protrude into the track switch 16.

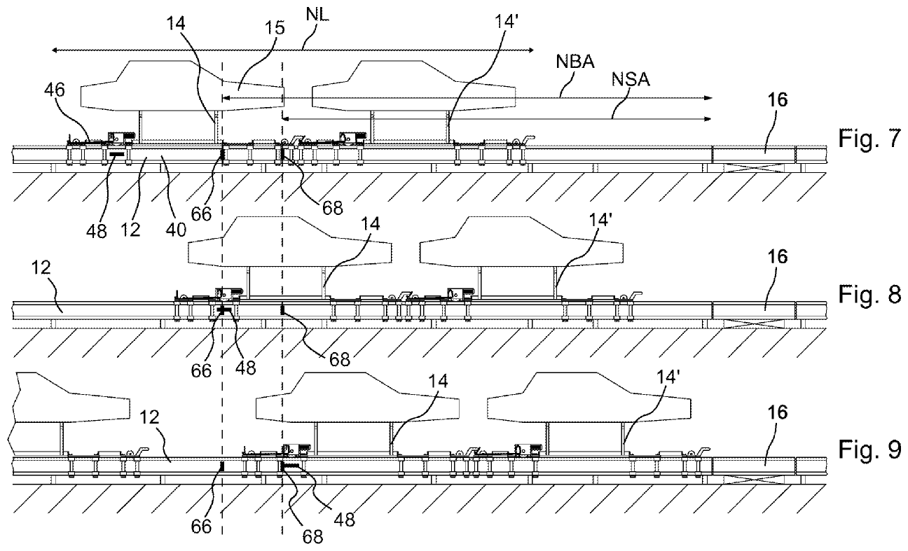

In FIGS. 7 to 9, the same portion of the conveyor section 12 upstream of a track switch 16 is shown. However, here a coupled vehicle combination consisting of a conveyor trolley 14 and a broken-down conveyor trolley 14′ moves toward the track switch 16.

For this emergency travel situation the controller 30 has transferred other waypoints to the moving trolley controller 46 of the towing conveyor trolley 14 (see FIG. 7). Due to the increased functional length in emergency operation NL, an emergency braking waypoint 66 has been displaced upstream of an emergency braking distance NBA. An emergency stop waypoint 68 has also been displaced upstream.

In this manner, the vehicle combination consisting of the two conveyor trolleys 14 and 14′, as visible in FIG. 9, also optimally comes to a standstill upstream of the track switch 16 in spite of its greater functional length NL.

The braking waypoint 60 and the stop waypoint 62 once again apply to the conveyor trolley 14 following the vehicle combination, so that effectively the waypoints have been only temporarily displaced.

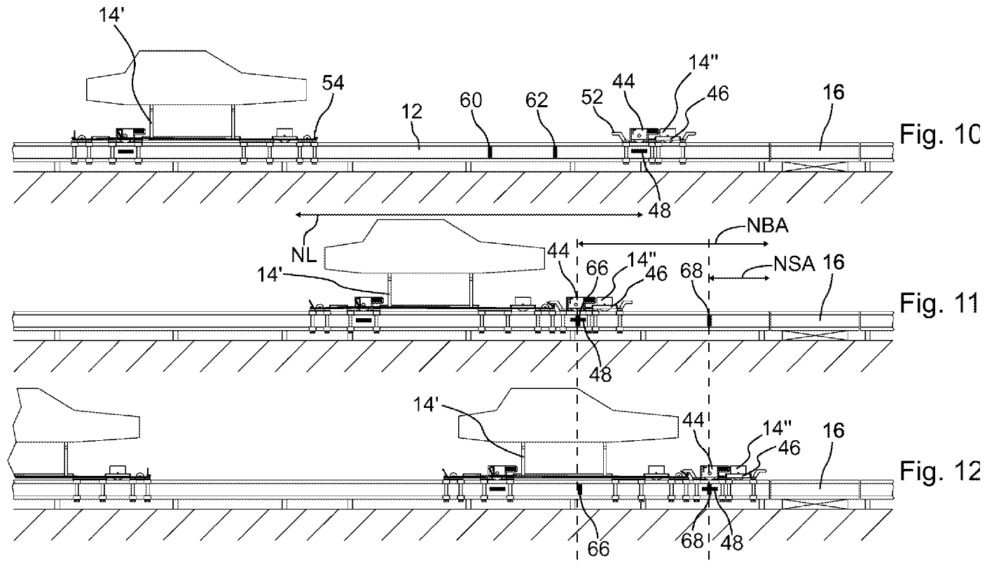

In FIGS. 10 to 12 the portion of the conveyor section 12 upstream of the track switch 16 is shown once again.

However, here a specially designed towing trolley 14″ is used. This is clearly of shorter construction than the conveyor trolley 14 and is not provided for conveying workpieces. Additionally the towing trolley 14″ may be designed as a mobile emergency device which may be used by operating personnel on any point of the track. Should the towing trolley 14″ lack the required weight in order to transmit a sufficient drive force, spring-loaded contact rollers may be provided for the drive 44.

In FIG. 10 the towing trolley 14″, coming from the right, moves toward the broken-down conveyor trolley 14′. In this case, for the towing procedure, the conveyor trolley 14 is not pushed but pulled.

In the coupled-on state the vehicle combination consisting of the broken-down conveyor trolley 14′ and the towing trolley 14″ has an only slightly extended functional length in emergency operation NL, relative to the functional length in normal operation BL.

As visible in FIGS. 11 and 12, the controller 30 displaces the emergency braking waypoint 66 to an emergency braking distance NBA downstream relative to the original position, since now the reader device 48 in the vehicle combination is located further forward than on a normal conveyor trolley 14. Similarly, the emergency stop waypoint 68 has been displaced downstream. Since the towing trolley 14″ is also able to generate less braking acceleration, as a further differing trolley parameter compared to a conveyor trolley 14, the emergency braking distance NBA is located relatively further upstream of the emergency stop waypoint 68.

What is claimed is:

1. A conveyor system comprising:
a) a conveyor section,
b) at least one first moving trolley which carries along a dedicated drive and is movable with the latter along the conveyor section and which has a first trolley parameter, and
c) a controller which, taking into consideration the first trolley parameter, triggers various actions with the aid of waypoints along the conveyor section,
wherein
d) at least one second moving trolley having a second trolley parameter differing from the first trolley parameter is provided, and
e) the controller is designed to place at least one waypoint along the conveyor section, at which waypoint a certain action is triggered, for the second moving trolley at a different position along the conveyor section than for the first moving trolley.

2. The conveyor system as claimed in claim 1, wherein the first and second trolley parameter is a trolley length, a mass, a maximum acceleration, a speed and/or a functional length of the moving trolleys.

3. The conveyor system as claimed in claim 1, wherein the second trolley parameter -of the second moving trolley differs from the first trolley parameter of the first moving trolley due to a coupling of two moving trolleys.

4. The conveyor system as claimed in claim 1, wherein one of the two coupled moving trolleys is a moving trolley which has broken down due to a technical fault.

5. The conveyor system as claimed in claim 1, wherein one of the two coupled moving trolleys is a towing trolley.

6. The conveyor system as claimed in one claim 1, wherein the controller is designed such that the specific action which is carried out at the waypoint also takes into consideration the difference of the second trolley parameter from the first trolley parameter.

7. The conveyor system as claimed in claim 1, wherein the two moving trolleys carry a moving trolley controller with a waypoint storage device and a device for detecting the actual position along the conveyor section and the second moving trolley stores in the waypoint storage device a different waypoint for the specific action.

8. The conveyor system as claimed in claim 1, wherein the displaced waypoint leads to the application of emergency travel parameters on the second moving trolley.

9. A method for controlling a conveyor system comprising a conveyor section, at least one first moving trolley which carries along a dedicated drive and is movable with the latter along the conveyor section and which has a first trolley parameter, and a controller which, taking into consideration the first trolley parameter, triggers various actions with the aid of waypoints along the conveyor section,
wherein the method comprises the following steps:
providing at least one second moving trolley having a second trolley parameter differing from the first trolley parameter;
placing at least one waypoint along the conveyor section, at which waypoint a certain action is triggered, for the second moving trolley at a different position along the conveyor section than for the first moving trolley.

10. The method as claimed in claim 9, further comprising the following steps:
coupling a different moving trolley for towing a moving trolley which has broken down due to a technical fault, whereby the second moving trolley is produced; and
moving the second moving trolley, by taking into consideration the displaced waypoint.

11. The method as claimed in claim 10, wherein the different moving trolley is coupled to the moving trolley in a portion of the conveyor section which is difficult to access for operating personnel
